(19) United States
(12) Patent Application Publication
(10) Pub. No.: US 2024/0101053 A1
(43) Pub. Date: Mar. 28, 2024

(54) SYSTEMS AND METHODS FOR PREDICTING COMPONENT LIFE BASED ON DUTY CYCLE ESTIMATED FROM ROAD SURFACE CONDITIONS

(71) Applicant: STEERING SOLUTIONS IP HOLDING CORPORATION, SAGINAW, MI (US)

(72) Inventors: MICHAEL R. STORY, SAGINAW, MI (US); ANDREW J. FRANK, AUBURN HILLS, MI (US)

(21) Appl. No.: 18/475,289

(22) Filed: Sep. 27, 2023

Related U.S. Application Data
(60) Provisional application No. 63/410,564, filed on Sep. 27, 2022.

(51) Int. Cl. B60R 16/023; B60W 40/068; G08B 21/18

(52) U.S. Cl. CPC B60R 16/0232; B60W 40/068; G08B 21/182

(57) ABSTRACT

A method for predicting component life. The method includes receiving at least one vehicle signal, calculating at least one road surface condition metric based on the at least one vehicle signal, and calculating a duty cycle for at least one vehicle component. The method also includes calculating a remaining component life value for the at least one vehicle component based on the duty cycle for the at least one vehicle component and the at least one road surface condition metric.

### CROSS-REFERENCES TO RELATED APPLICATIONS

This U.S. patent application claims the benefit and priority to U.S. Patent Provisional Application Ser. No. 63/410,564, filed Sep. 27, 2022, the entire disclosure of which is hereby incorporated by reference.

### TECHNICAL FIELD

This disclosure related to vehicle component life predictions, and in particular to systems and methods for predicting component life based on duty cycle estimated from one or more road conditions.

### BACKGROUND

Vehicles, such as cars, trucks, sport utility vehicles, crossovers, mini-vans, marine craft, aircraft, all-terrain vehicles, recreational vehicles, or other suitable vehicles, include a various systems, such as a steering system (e.g., such as an electronic power steering (EPS) system, a steer-by-wire (SbW) steering system, a hydraulic steering system, or other suitable steering system), suspension system, propulsion system, and the like. Components of such systems are subject to general wear and tear. As operating conditions for one vehicle may vary from those of another vehicle, component life (e.g., the length of time a component can function before experiencing undesirable operating characteristics) may vary from vehicle to vehicle.

### SUMMARY

This disclosure relates generally to component life prediction.

An aspect of the disclosed embodiments includes a method for predicting component life. The method includes receiving at least one vehicle signal, calculating at least one road surface condition metric based on the at least one vehicle signal, and calculating a duty cycle for at least one vehicle component. The method also includes calculating a remaining component life value for the at least one vehicle component based on the duty cycle for the at least one vehicle component and the at least one road surface condition metric.

Another aspect of the disclosed embodiments includes a system for predicting component life. The system includes a processor and a memory. The memory includes instructions that, when executed by the processor, cause the processor to: receive at least one vehicle signal; calculate at least one road surface condition metric based on the at least one vehicle signal; calculate a duty cycle for at least one vehicle component; and calculate a remaining component life value for the at least one vehicle component based on the duty cycle for the at least one vehicle component and the at least one road surface condition metric.

Another aspect of the disclosed embodiments includes an apparatus for predicting component life includes a processor, and a memory. The memory includes instructions that, when executed by the processor, cause the processor to: receive at least one vehicle signal via a vehicle controller area network bus; calculate at least one road surface condition metric based on the at least one vehicle signal, the at least one road surface condition metric corresponding to at least one of a road roughness, a road friction, and a road surface type; calculate a duty cycle for at least one vehicle component; and calculate a remaining component life value for the at least one vehicle component based on the duty cycle for the at least one vehicle component and the at least one road surface condition metric.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a vehicle controller according to the principles of the present disclosure.

FIG. 3 is a flow diagram generally illustrating a component life prediction method according to the principles of the present disclosure.

FIG. 4 is a flow diagram generally illustrating an alternative component life prediction method according to the principles of the present disclosure.

FIG. 5 is a flow diagram generally illustrating an alternative component life prediction method according to the principles of the present disclosure.

FIG. 6 is a flow diagram generally illustrating an alternative component life prediction method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, vehicles, such as cars, trucks, sport utility vehicles, crossovers, mini-vans, marine craft, aircraft, all-terrain vehicles, recreational vehicles, or other suitable vehicles, include a various systems, such as a steering system (e.g., such as an electronic power steering (EPS) system, a steer-by-wire (SbW) steering system, a hydraulic steering system, or other suitable steering system), suspension system, propulsion system, and the like. Components of such systems are subject to general wear and tear. As operating conditions for one vehicle may vary from those of another vehicle, component life (e.g., the length of time a component can function before experiencing undesirable operating characteristics) may vary from vehicle to vehicle.

Typically, such components may wear out or fail to long exposure or high loading intensity on rough roads, without any indication being given prior to excessive wear or catastrophic failure. Although many wear and failure models exist for design purposes, many of them are not computed in real-time and updated as the vehicle is driven. As different road surface algorithms are advancing and able to predict various road metrics in real-time, new wear and failure models that also run in real time are now a possibility.

Accordingly, systems and methods, such as those described herein, configured to predict component life, may be desirable. In some embodiments, the systems and methods described herein may be configured to estimate a duty cycle for a component based on a state of the vehicle state and the road surface conditions of the road being traversed by the vehicle. The systems and methods described herein may be configured to use road surface condition (e.g., such as road type, roughness, friction, and the like) as well as the vehicle state to estimate a duty cycle. The systems and methods described herein may be configured to represent a remaining useful life of the component as a function of estimated duty cycle and time spent at a given duty cycle value.

In some embodiments, the systems and method described herein may be configured to determine the remaining useful life for a component that has a relatively high correlation with road surface conditions, such as a suspension subsystem (e.g., where such knowledge could lead to avoiding undesirable outcomes such as tire failure, brake judder, reduced comfort and/or vehicle control due to worn dampers or suspension bushings, and the like) and/or any other suitable vehicle system. The systems and methods described herein may be configured to provide a warning to the vehicle operator (e.g., which may be referred to as a driver) indicating a need for vehicle maintenance when the part life crosses a certain threshold.

In some embodiments, the systems and methods described herein may be configured to predict component life based on a duty cycle, which is estimated by road surface type, roughness, friction, and the like. In some embodiments, the systems and methods described herein may be configured to determine an impact on the component of the vehicle based on the duty cycle associated with the component. In some embodiments, the systems and methods described herein may be configured determine a useful remaining component life for the component using any suitable input including those described herein and/or other suitable inputs, such as a running time (e.g., operating time), one or more statistics (e.g., how many times the vehicle has been parked, how many times the vehicle has been started, how many times the vehicle has stalled, how many times the vehicle has been in a temperature above an upper threshold temperature, how many times the vehicle has been in a temperature below a lower threshold temperature, how many times the vehicle has operated longer than a threshold operating period, any other suitable statistic, or a combination thereof).

In some embodiments, the systems and methods described herein may be configured to receive at least one vehicle signal. The at least one vehicle signal may be received via a vehicle controller area network bus and/or may be associated with a vehicle system, such as a suspension system, a steering system, a propulsion system, and/or the like. The steering system may include any suitable steering system, such as those described herein or any other suitable steering system. The at least one vehicle signal may be associated with at least one of wheel slip value, wheel speed, vehicle acceleration, handwheel angle, engine torque, brake torque, an EPS torque, and EPS motor velocity, any other suitable aspect of the vehicle, or a combination thereof.

The systems and methods described herein may be configured to calculate at least one road surface condition metric based on the at least one vehicle signal. The at least one road surface condition metric may correspond to and/or indicate at least one of a road roughness, a road friction, a road surface type, any other suitable road condition, or a combination thereof. The systems and methods described herein may be configured to calculate a duty cycle for at least one vehicle component. The systems and methods described herein may be configured to calculate a remaining component life value for the at least one vehicle component based on the duty cycle for the at least one vehicle component and the at least one road surface condition metric. The systems and methods desired herein may be configured to, based on a determination that the remaining component life value is less than a threshold, generate a warning. The systems and methods described herein may be configured to provide the warning to the vehicle operator via an in vehicle display, a computing device (e.g., such as a mobile computing device or other suitable computing device), and/or the like.

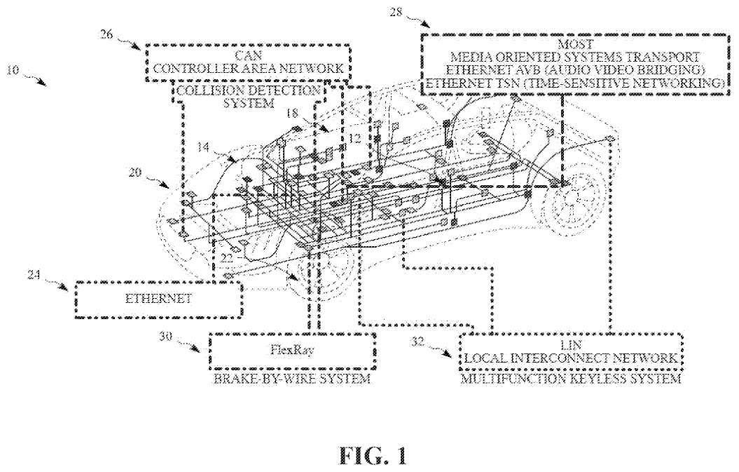

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a steering wheel, and other such components are disposed in the compartment 18 of the vehicle 10. The propulsion controls may be actuated or controlled by a driver of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

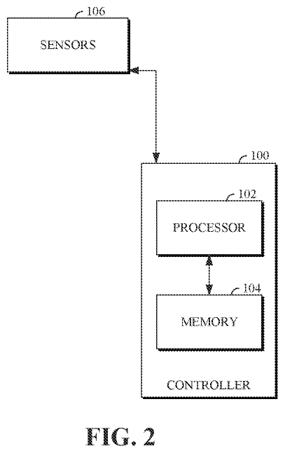

In some embodiments, the steering system may include a controller, such as controller 100, as is generally illustrated in FIG. 2. The controller 100 may include any suitable controller. The controller 100 may be configured to control, for example, the various functions of the vehicle systems described herein. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various functions of the steering system and/or any other suitable function, including those of the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more motor angle sensors or devices, other suitable sensors or devices, or a combination thereof. The one or more signals may indicate a handwheel torque, a handwheel angel, a motor angle or motor position, a vehicle speed, other suitable information, or a combination thereof.

In some embodiment, the controller 100 may be configured to predict a remaining useful life of a vehicle component. For example, the controller 100 may receive at least one vehicle signal (e.g., from one or more of the sensors 106 or other suitable sensor or data generating device of the vehicle 10 or from one or more remotely or proximately located computing devices, such as a cloud computing device, a mobile computing device, and/or the like).

The controller 100 may calculate at least one road surface condition metric based on the at least one vehicle signal. The controller 100 may calculate a duty cycle for at least one vehicle component. The controller 100 may calculate a remaining component life value for the at least one vehicle component based on the duty cycle for the at least one vehicle component and the at least one road surface condition metric. The controller 100 may, based on a determination that the remaining component life value is less than a threshold, generate a warning. The controller 100 may provide the warning to the vehicle operator via an in vehicle display of the vehicle 10, a computing device (e.g., such as a mobile computing device or other suitable computing device), and/or the associated and/or in communication with the vehicle 10.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

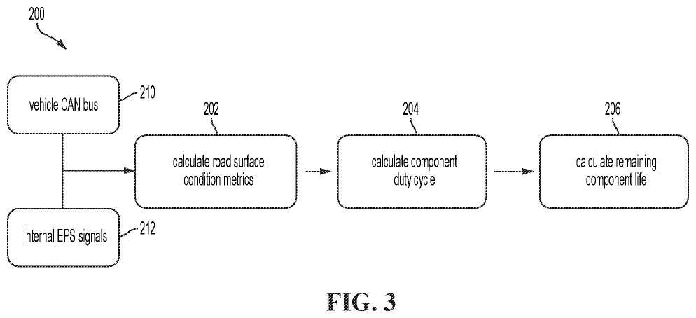

FIG. 3 is a flow diagram generally illustrated a component life prediction method 200 according to the principles of the present disclosure. At 202, the method 200 calculates road surface condition metrics. For example, the controller 100 may calculate one or more road surface condition metrics using one or more vehicle signals received via the vehicle CAN bus at 210 and/or using internal EPS signals at 212.

At 204, the method 200 calculates a component duty cycle. For example, the controller 100 may calculate a duty cycle for at least one component of the vehicle 10.

At 206, the method 200 calculates a remaining component life. For example, the controller 100 may calculate a remaining component life for the at least one component of the vehicle 10.

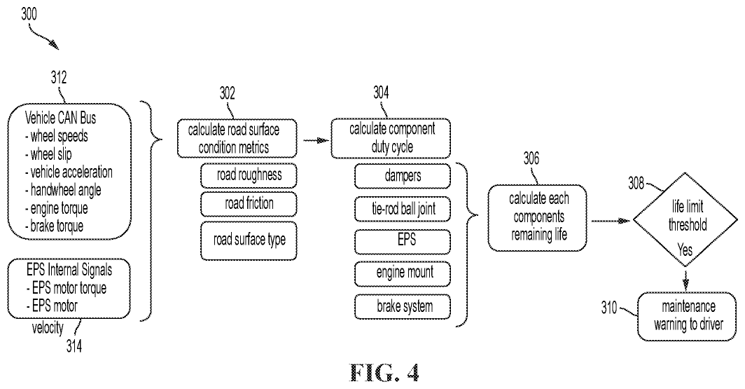

FIG. 4 generally illustrates an alternative component life prediction method 300 according to the principles of the present disclosure. At 302, the method 300 calculates road surface condition metrics. For example, the controller 100 may calculate one or more road surface condition metrics using one or more vehicle signals received via the vehicle CAN bus at 312 (e.g., which may include one or more of wheel speeds, wheel slip, vehicle acceleration, handwheel angle, engine torque, brake torque, any other suitable signal or data received via the vehicle CAN bus, or a combination thereof) and/or using internal EPS signals at 314 (e.g., which may include EPS motor torque, EPS motor velocity, other suitable EPS signals or data, or a combination thereof).

At 304, the method 300 calculates a component duty cycle. For example, the controller 100 may calculate a duty cycle for at least one component of the vehicle 10. The at least one component of the vehicle 10 may be associated with dampers, tie-rod ball joints, the EPS system (e.g., or other suitable steering system), one or more engine mounts, the brake system, the suspension system, and/or any other suitable component or system of the vehicle 10.

At 306, the method 300 calculates a remaining component life. For example, the controller 100 may calculate a remaining component life for the at least one component of the vehicle 10.

At 308, the method 300 determines whether the remaining component life is less than a threshold or limit. For example, the controller 100 may determine whether the remaining component life is less than the threshold or limit. If the controller 100 determines that the remaining component life is greater than the threshold or limit, the controller 100 may discard the remaining component life and/or take other suitable act. Alternatively, if the controller 100 determines that the remaining component life for the at least one component of the vehicle 10 is less than the threshold or limit, the method 300 continues at 310.

At 310, the method 300 generate a maintenance warning to the driver. For example, the controller 100 may generate and/or provide a maintenance warning indicating the remaining component life, a reminder for maintenance, and/or the like.

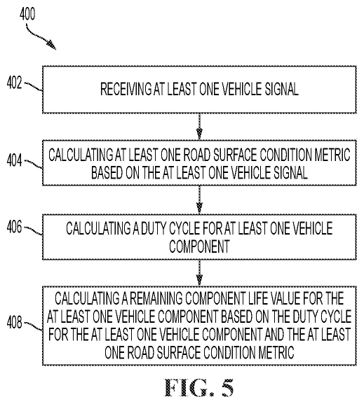

FIG. 5 is a flow diagram generally illustrating an alternative component life prediction method 400 according to the principles of the present disclosure. At 402, the method 400 receives at least one vehicle signal. For example, the controller 100 may receive the at least one vehicle signal.

At 404, the method 400 calculates at least one road surface condition metric based on the at least one vehicle signal. For example, the controller 100 may calculate at least one road surface condition metric based on the at least one vehicle signal.

At 406, the method 400 calculates a duty cycle for at least one vehicle component. For example, the controller 100 may calculate the duty cycle for the at least one vehicle component.

At 408. The method 400 calculates a remaining component life value for the at least one vehicle component based on the duty cycle for the at least one vehicle component and the at least one road surface condition metric. For example, the controller 100 may calculate the remaining component life value for the at least one vehicle component based on the duty cycle for the at least one vehicle component and the at least one road surface condition metric.

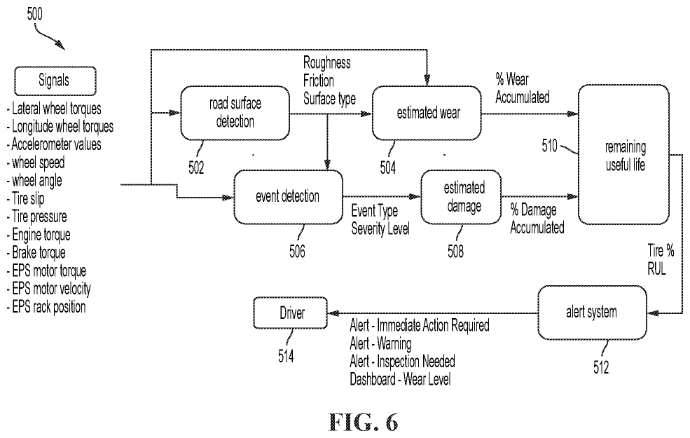

FIG. 6 is a flow diagram generally illustrating an alternative component life prediction method 500 according to the principles of the present disclosure. At 502, the method 500 detects a road surface condition using various input signals. For example, the controller 100 may detect the road surface condition. The various input signals may include any suitable signals, including, but not limited to, lateral wheel torque signals, longitude wheel torque signals, accelerometer signals, wheel speed signals, wheel angle signals, tire slip signals, tire pressure signals, engine torque signals, brake signals, EPS moor torque signals, EPS motor velocity signals, EPS rack position signals, and/or the like. The controller 100 may determine and/or output various road surface characteristics, including, but not limited to, roughness, friction, surface type, and/or the like.

At 504, the method 500 estimates component wear based on the road surface characteristics. For example, the controller 100 may estimate the component ware based on the road surface characteristics. The component wear may correspond to any suitable component of the vehicle, including one or more tires, one or more wheels, one or more actuators, and/or the like. The controller 100 may generate and/or output a wear accumulation percentage for the component based on the road surface characteristics.

At 506, the method 500 detects one or more events based on the various input signals. For example, the controller 100 may detect the one or more events based on the various input signals. The events may include any suitable events, including, but not limited to, tire slip, oversteering, understeering, collisions, and/or the like. The controller 100 may generate and/or output an event type and/or a severity level of a detected event. The controller 100 may determine the severity level of a detected event based on a lookup table, and/or any other suitable information or data.

At 508, the method 500 estimates damage based on the event type and/or severity level. For example, the controller 100 may estimate an amount of damage to the component (e.g., and/or any other suitable component or feature of the vehicle 10) based on the event type and/or severity level. For example, the event type may include a tire hitting a curb and the severity level may indicate a medium severity. The controller 100 may determine a damage accumulation percentage of a corresponding tire based on the current event, the event type, the severity level, and a usage and/or damage history of the tire.

At 510, the method 500 determines a remaining useful life. For example, the controller 100 may determine the remaining useful life of the component based on the damage accumulated percentage. The controller 100 may generate and/or output a component remaining useful life percentage (e.g., such as a tire remaining useful like percentage).

At 512, the method 500 generates an alert using an alert system. For example, the controller 100 may generate an alert, using any suitable alert generation system, based on the component remaining useful life percentage. The alert may indicate to take immediate action, a warning, that an inspection is needed, a wear level, and/or the like.

At 514, the method 500 provides the alert to an operator of the vehicle. For example, the controller 100 may provide the operator of the vehicle 10 with the alert. The controller 100 may provide the alert in any suitable manner, including, but not limited to, using a dashboard, using an infotainment system, using a mobile computing device, and/or the like.

In some embodiments, a method for predicting component life includes receiving at least one vehicle signal, calculating at least one road surface condition metric based on the at least one vehicle signal, and calculating a duty cycle for at least one vehicle component. The method also includes calculating a remaining component life value for the at least one vehicle component based on the duty cycle for the at least one vehicle component and the at least one road surface condition metric.

In some embodiments, the at least one vehicle signal is received via a vehicle controller area network bus. In some embodiments, the at least one vehicle signal is associated with at least one of wheel slip value, wheel speed, vehicle acceleration, handwheel angle, engine torque, and brake torque. In some embodiments, the at least one vehicle signal is associated with a vehicle system. In some embodiments, the vehicle system includes a suspension system. In some embodiments, the vehicle system includes a steering system. In some embodiments, the steering system includes an electronic power steering system. In some embodiments, the at least one vehicle signal is associated with at least one of electronic power steering torque and electronic power steering motor velocity. In some embodiments, the at least one road surface condition metric corresponds to at least one of a road roughness, a road friction, and a road surface type. In some embodiments, the method also includes, based on a determination that the remaining component life value is less than a threshold, generating a warning.

In some embodiments, a system for predicting component life includes a processor and a memory. The memory includes instructions that, when executed by the processor, cause the processor to: receive at least one vehicle signal; calculate at least one road surface condition metric based on the at least one vehicle signal; calculate a duty cycle for at least one vehicle component; and calculate a remaining component life value for the at least one vehicle component based on the duty cycle for the at least one vehicle component and the at least one road surface condition metric.

In some embodiments, the at least one vehicle signal is received via a vehicle controller area network bus. In some embodiments, the at least one vehicle signal is associated with at least one of wheel slip value, wheel speed, vehicle acceleration, handwheel angle, engine torque, and brake torque. In some embodiments, the at least one vehicle signal is associated with a vehicle system. In some embodiments, the vehicle system includes a suspension system. In some embodiments, the vehicle system includes a steering system. In some embodiments, the steering system includes an electronic power steering system. In some embodiments, the at least one vehicle signal is associated with at least one of electronic power steering torque and electronic power steering motor velocity. In some embodiments, the at least one road surface condition metric corresponds to at least one of a road roughness, a road friction, and a road surface type. In some embodiments, the instructions further cause the processor to, based on a determination that the remaining component life value is less than a threshold, generate a warning.

In some embodiments, an apparatus for predicting component life includes a processor, and a memory. The memory includes instructions that, when executed by the processor, cause the processor to: receive at least one vehicle signal via a vehicle controller area network bus; calculate at least one road surface condition metric based on the at least one vehicle signal, the at least one road surface condition metric corresponding to at least one of a road roughness, a road friction, and a road surface type; calculate a duty cycle for at least one vehicle component; and calculate a remaining component life value for the at least one vehicle component based on the duty cycle for the at least one vehicle component and the at least one road surface condition metric.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A method for predicting component life, the method comprising:
receiving at least one vehicle signal;
calculating at least one road surface condition metric based on the at least one vehicle signal;
calculating a duty cycle for at least one vehicle component; and
calculating a remaining component life value for the at least one vehicle component based on the duty cycle for the at least one vehicle component and the at least one road surface condition metric.

2. The method of claim 1, wherein the at least one vehicle signal is received via a vehicle controller area network bus.

3. The method of claim 2, wherein the at least one vehicle signal is associated with at least one of wheel slip value, wheel speed, vehicle acceleration, handwheel angle, engine torque, and brake torque.

4. The method of claim 1, wherein the at least one vehicle signal is associated with a vehicle system.

5. The method of claim 4, wherein the vehicle system includes a suspension system.

6. The method of claim 4, wherein the vehicle system includes a steering system.

7. The method of claim 6, wherein the steering system includes an electronic power steering system.

8. The method of claim 7, wherein the at least one vehicle signal is associated with at least one of electronic power steering torque and electronic power steering motor velocity.

9. The method of claim 1, wherein the at least one road surface condition metric corresponds to at least one of a road roughness, a road friction, and a road surface type.

10. The method of claim 1, further comprising, based on a determination that the remaining component life value is less than a threshold, generating a warning.

11. A system for predicting component life, the system comprising:
a processor; and
a memory including instructions that, when executed by the processor, cause the processor to:
receive at least one vehicle signal;
calculate at least one road surface condition metric based on the at least one vehicle signal;
calculate a duty cycle for at least one vehicle component; and
calculate a remaining component life value for the at least one vehicle component based on the duty cycle for the at least one vehicle component and the at least one road surface condition metric.

12. The system of claim 11, wherein the at least one vehicle signal is received via a vehicle controller area network bus.

13. The system of claim 12, wherein the at least one vehicle signal is associated with at least one of wheel slip value, wheel speed, vehicle acceleration, handwheel angle, engine torque, and brake torque.

14. The system of claim 11, wherein the at least one vehicle signal is associated with a vehicle system.

15. The system of claim 14, wherein the vehicle system includes a suspension system.

16. The system of claim 14, wherein the vehicle system includes a steering system.

17. The system of claim 16, wherein the steering system includes an electronic power steering system.

18. The system of claim 17, wherein the at least one vehicle signal is associated with at least one of electronic power steering torque and electronic power steering motor velocity.

19. The system of claim 11, wherein the at least one road surface condition metric corresponds to at least one of a road roughness, a road friction, and a road surface type.

20. An apparatus for predicting component life, the apparatus comprising:
a processor; and
a memory including instructions that, when executed by the processor, cause the processor to:
receive at least one vehicle signal via a vehicle controller area network bus;
calculate at least one road surface condition metric based on the at least one vehicle signal, the at least one road surface condition metric corresponding to at least one of a road roughness, a road friction, and a road surface type;
calculate a duty cycle for at least one vehicle component; and
calculate a remaining component life value for the at least one vehicle component based on the duty cycle for the at least one vehicle component and the at least one road surface condition metric.
